(19) United States
(12) Patent Application Publication
(10) Pub. No.: US 2020/0049149 A1
(43) Pub. Date: Feb. 13, 2020

(54) COMPRESSOR

(71) Applicant: SANDEN AUTOMOTIVE COMPONENTS CORPORATION, Isesaki-shi, Gunma (JP)

(72) Inventors: Kanetaka MIYAZAWA, Isesaki-shi, Gunma (JP); Hiroshi ENOMOTO, Isesaki-shi, Gunma (JP)

(21) Appl. No.: 16/342,908

(22) PCT Filed: Sep. 7, 2017
(86) PCT No.: PCT/JP2017/033162

§ 371 Date: Apr. 17, 2019

(30) Foreign Application Priority Data
Oct. 31, 2016 (JP) 2016-213618

(51) Int. Cl. F04C 29/00; F04C 2/02

(52) U.S. Cl. CPC F04C 29/00; F05C 2251/00; F04C 2/025

(57) ABSTRACT

Corrosion due to salt water, or the like, is prevented or suppressed between fastening end portions of housing members, while minimizing increase in production cost with respect to corrosion. A housing 10 of a compressor 1 has a front housing 11, a center housing 12, and a rear housing 13. The front housing 11 and the center housing 12 are fastened to each other by a plurality of fastening members 31, and mutual fastening end portions (111 and 121) thereof are welded together. The center housing 12 and the rear housing 13 are fastened to each other by a plurality of fastening members 32, and mutual fastening end portions (122 and 131) thereof are welded together. A weld bead W1 is formed between the fastening end portion 111 and the fastening end portion 121, and a weld bead W2 is formed between the fastening end portion 122 and the fastening end portion 131.

### TECHNICAL FIELD

The present invention relates to a compressor and a method of manufacturing the same and, in particular, relates to a compressor having a housing including a plurality of housing members.

### BACKGROUND ART

As an example of a compressor of this type, a compressor disclosed in Patent Document 1 is known. In the compressor disclosed in Patent Document 1, a housing includes a front case accommodating compression mechanism, a motor case accommodating an electric motor, and a frame arranged between the front case and the motor case, and these are fastened together by bolts. Sealing is performed by an O-ring between the end surface of the front case and one end surface of the frame and between the end surface of the motor case and the other end surface of the frame.

Another known example of the compressor is disclosed in Patent Document 2. In a compressor disclosed in Patent Document 2, a housing (sealed container) includes a container tube member, a container lower member, and a container upper member, and these are welded to each other. The upper end portion of the container tube member and the container upper member are engaged with each other, and the lower end portion of the container tube member and the container lower member are engaged with each other, and the engaged portions are welded over the entire periphery in the housing outer peripheral direction.

### REFERENCE DOCUMENT LIST

### Patent Documents

Patent Document 1: JP H09-42156 A

Patent Document 2: JP 2003-155978 A

### SUMMARY OF THE INVENTION

### Problem to be Solved by the Invention

However, in the compressor disclosed in Patent Document 1, in order to prevent corrosion of the end surfaces due to intrusion of salt water or the like between the end surfaces, it is still necessary to secure a sufficient surface pressure between the end surfaces. Thus, the required number of bolts is increased. Furthermore, it is also necessary to control the fastening torque of each bolt, so that the production cost for corrosion tends to increase.

In the compressor disclosed in Patent Document 2, the corrosion due to the intrusion of salt water or the like is prevented or suppressed by welding the entire periphery of the engaged portions. However, it is necessary to secure the pressure strength of the housing by the welding strength. Thus, it is necessary to strictly perform quality control for welding such as inner defect of the weld bead, so that, as in the compressor disclosed in Patent Document 1, the production cost for corrosion tends to increase.

Accordingly, it is an object of the present invention to provide a compressor having a housing including a plurality of housing members, and the compressor is able to prevent or suppress corrosion due to salt water or the like between fastening end portions of the housing member while minimizing an increase in production cost for corrosion.

### Means for Solving the Problem

According to an aspect of the present invention, there is provided a compressor including a housing made of an aluminum alloy and a compression mechanism accommodated in the housing. In the compressor, the housing has a first housing member and a second housing member which are fastened to each other by a plurality of fastening members and fastening end portions of the fastening members are welded to each other, and a weld bead is formed between the fastening end portion of the first housing member and the fastening end portion of the second housing member.

### Effects of the Invention

In the compressor according to the aspect of the present invention, the first housing member and the second housing member are fastened to each other by the plurality of fastening members, and the mutual fastening end portions are welded to each other, and as a result of this welding, a weld bead is formed between the fastening end portion of the first housing member and the fastening end portion of the second housing member. That is, the compressor according to the aspect of the present invention has a hybrid joining structure in which the fastening end portions are joined to each other by performing both the welding and the fastening by the fastening members.

Here, by providing the plurality of fastening members, it is possible to easily ensure a reaction force to the load urging the fastening end portions away from each other, so that all or the major portion of the pressure strength of the housing can be borne by the plurality of fastening members. Accordingly, low strength welding between the first housing member and the second housing member is allowed. Thus, as compared with the prior art, it is possible to reduce the welding depth, and to relax the welding quality control for the inner defect of the weld bead or the like. Furthermore, since the weld bead is formed between the fastening end portion of the first housing member and the fastening end portion of the second housing member, this weld bead functions as a shield wall for the salt water or the like, and thus, it is possible to easily prevent or suppress intrusion of salt water or the like between the fastening end portions and the resultant corrosion between the fastening end portions. Accordingly, as compared with the prior art, it is possible, for example, to reduce the number of the fastening members and to relax the fastening torque control of each fastening member.

As described above, in the compressor, while suppressing an increase in the production cost of the compressor for corrosion, it is possible to prevent or suppress intrusion of salt water or the like between the fastening end portions of the first housing member and the second housing member and the resultant corrosion between the fastening end portions.

### BRIEF DESCRIPTION OF THE DRAWINGS

FIG. 1 is a schematic sectional view of a compressor according to an embodiment of the present invention.

FIG. 2 is a schematic external side view of a housing of the compressor.

FIG. 3 is a front view of the housing schematically illustrated in FIG. 2.

FIG. 4 is a rear view of the housing schematically illustrated in FIG. 2.

FIG. 5 is a partial enlarged sectional view taken along arrow line A-A of FIG. 3.

FIG. 6 is a partial enlarged sectional view taken along arrow line B-B of FIG. 4.

FIG. 7 is a sectional view taken along arrow line C-C of FIG. 5, and a conceptual view (partial enlarged sectional view) taken along arrow line C′-C′ of FIG. 6.

### MODE FOR CARRYING OUT THE INVENTION

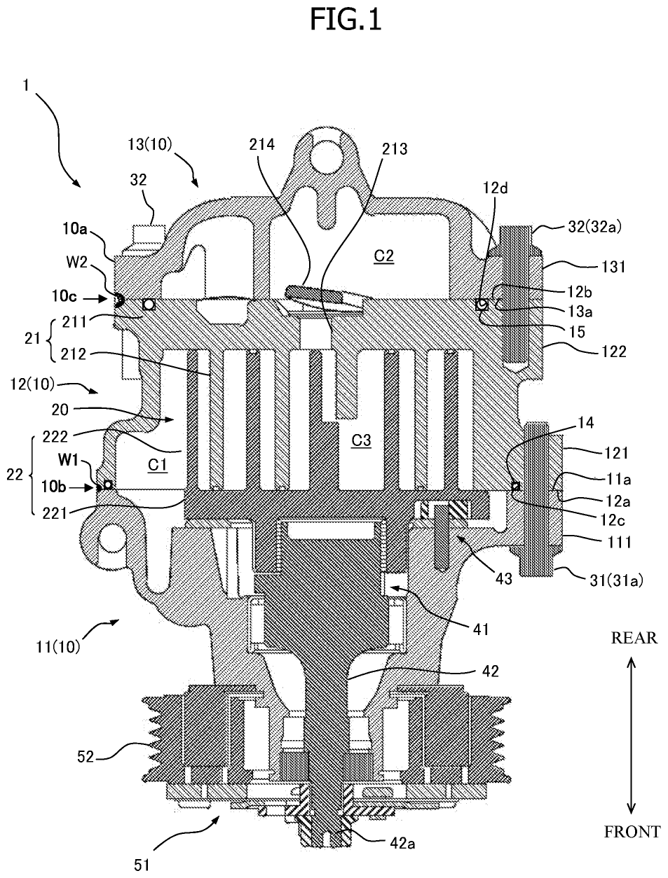

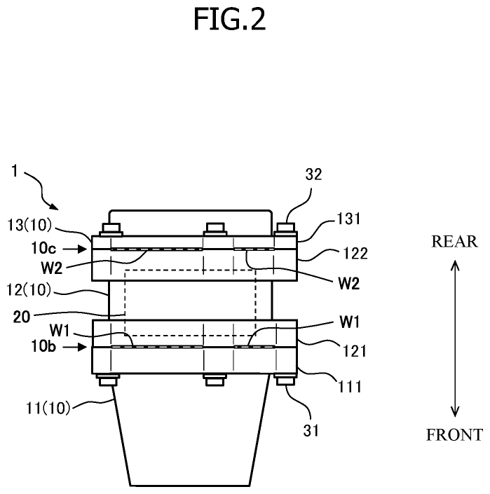

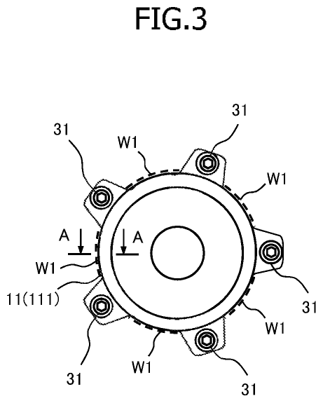

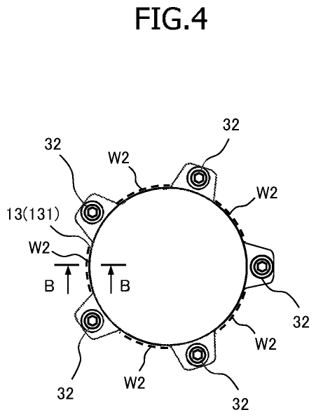

In the following, an embodiment of the present invention will be described with reference to the attached drawings. FIG. 1 is a schematic sectional view of a compressor 1 according to an embodiment of the present invention. FIG. 2 is a schematic external view of the compressor 1, FIG. 3 is a front view of the same, and FIG. 4 is a rear view of the same.

The compressor 1 of the present embodiment is incorporated, for example, in the refrigerant circuit of a vehicle air conditioner, and compresses refrigerant drawn from the refrigerant circuit (more specifically, the low pressure side thereof) to discharge the compressed refrigerant to the refrigerant circuit (more specifically, the high pressure side thereof). The compressor 1 includes a housing 10 of a substantially columnar outward appearance, and a compression mechanism 20 accommodated in the housing 10.

The housing 10 is a casting made of an aluminum alloy, more specifically, a casting aluminum alloy. As illustrated in FIG. 1, the housing 10 is divided in a plurality of portions (three portions in the present embodiment) in the extending direction of a drive shaft 42 of the compression mechanism 20 described below, and has a front housing 11, a center housing 12, and a rear housing 13. In the present embodiment, the front housing 11 and the center housing 12 are fastened to each other by a plurality of bolts 31 arranged at intervals in the peripheral direction in a state in which the end surfaces of their respective fastening end portions 111 and 121 (that is, a rear end surface 11a of the front housing 11 and a front end surface 12a of the center housing 12) abutted each other. The center housing 12 and the rear housing 13 are fastened to each other by a plurality of bolts 32 arranged at intervals in the peripheral direction in a state in which the end surfaces of their respective fastening end portions 122 and 131 (that is, a rear end surface 12b of the center housing 12 and a front end surface 13a of the rear housing 13) abutted each other. In the present embodiment, the fastening body of the front housing 11 and the center housing 12 and the fastening body of the center housing 12 and the rear housing 13 respectively correspond to the fastening bodies of “the first housing member and the second housing member” of the invention of the present application. Furthermore, in the present embodiment, the rear end surface 11a, the front end surface 12a, the rear end surface 12b, and the front end surface 13a respectively correspond to “the end surfaces” of the invention of the present application, and the bolts 31 and 32 respectively correspond to “the fastening members” of the invention of the present application.

In the present embodiment, as illustrated in FIGS. 2 through 4, the fastening end portions 111, 121, 122, and 131 are formed such that the insertion portions of the bolts 31 and 32 protrudes outwardly in the radial direction beyond the housing body portion.

Furthermore, in the present embodiment, the front end surface 12a of the center housing 12 has, on the inner side in the housing radial direction of the bolts 31, an annular groove (O-ring groove) 12c in which an O-ring 14 as a seal member is accommodated. The rear end surface 12b of the center housing 12 also has, on the inner side in the housing radial direction of the bolts 32, an annular groove (O-ring groove) 12d in which an O-ring 15 as a seal member is accommodated. The annular groove accommodating the O-ring 14, 15 may be formed in the rear end surface 11a of the front housing 11 and in the front end surface 13a of the rear housing 13.

Referring back to FIG. 1, in the housing 10, a suction chamber C1 and a discharge chamber C2 are provided. The suction chamber C1 is formed by the front housing 11 and the center housing 12. The suction chamber C1 communicates with the refrigerant circuit (the lower pressure side thereof) via a suction port (not illustrated) formed in the front housing 11. The discharge chamber C2 is formed by the center housing 12 and the rear housing 13. The discharge chamber C2 communicates with the refrigerant circuit (the high pressure side thereof) via a discharge port (not illustrated) formed in the rear housing 13.

The compression mechanism 20 compresses the refrigerant guided to the suction chamber C1 from the refrigerant circuit (the lower pressure side thereof) via the suction port. The compression mechanism 20 is a scroll compression mechanism, and includes a fixed scroll 21 and an orbiting scroll 22. The fixed scroll 21 has a base plate portion 211, and a spiral wrap 212 formed (provided upright) on one surface of the base plate portion 211. Similarly, the orbiting scroll 22 has a base plate portion 221, and a spiral wrap 222 formed (provided upright) on one surface of the base plate portion 221. The fixed scroll 21 and the orbiting scroll 22 are arranged so that their respective spiral wraps 212 and 222 are engaged with each other. The side walls of both spiral laps 212 and 222 partially come into contact with each other, so that a compression chamber C3 as a sealed space is formed between both the spiral wraps 212 and 222.

In the present embodiment, the fixed scroll 21 is formed integrally with the center housing 12. That is, the center housing 12 is formed as a bottomed cylinder the front end of which is an open end and the rear end of which is a closed end, and the fastening end portion (rear end wall) 122 of the center housing 12 constitutes the base plate portion 211 of the fixed scroll 21. A through-hole 213 is formed substantially at the center of the base plate portion 211 of the fixed scroll 21. The through-hole 213 functions as a discharge hole for discharging the refrigerant compressed by the compression mechanism 20 into the discharge chamber C2, and the through-hole 213 is opened and closed by a reed valve (discharge valve) 214.

The orbiting scroll 22 is connected to the drive shaft 42 via a crank mechanism 41. The crank mechanism 41 is configured to covert the rotational motion of the drive shaft 42 to the orbiting motion of the orbiting scroll 22. A crank mechanism having such a function is well-known, so a detailed description thereof will be left out. For example, the crank mechanism 41 may be of the same structure as the driven crank mechanism disclosed in JP 2013-160187 A. The orbiting scroll 22 is prevented from rotating by a rotation restricting mechanism 43.

An end portion 42a of the drive shaft 42 on the opposite side of the crank mechanism 41 (the orbiting scroll 22) protrudes to the exterior of the front housing 11, and a pulley 52 is connected to protruding end portion 42a of the drive shaft 42 via an electromagnetic clutch 51. The pulley 52 is provided so as to be rotatable, and is connected to an output pulley (not illustrated) on the drive source (the engine or the motor of the vehicle) side via a belt (not illustrated).

In the compressor 1, when the rotation of the pulley 52 accompanying the rotation of the output pulley is transmitted to the drive shaft 42 via the electromagnetic clutch 51, the drive shaft 42 rotates. The rotation of the drive shaft 42 is converted to an orbiting motion of the orbiting scroll 22 by the orbiting mechanism 41, so that the orbiting scroll 22 performs orbiting motion with respect to the fixed scroll 21. When the orbiting scroll 22 performs the orbiting motion, the compression chamber C3 is formed in the vicinity of the outer end portions of both spiral laps 212 and 222 by both spiral wraps 212 and 222 and, at the same time, the refrigerant guided to the suction chamber C1 from the refrigerant circuit (the low pressure side thereof) via the suction port is taken in by the compression chamber C3. After that, the compression chamber C3 having taken in the refrigerant moves toward the inner end portions of both spiral wraps 212 and 222, that is, toward the central portion of the base plate portions 211 and 221 while decreasing the volume. As a result, the refrigerant in the compression chamber C3 is compressed. The refrigerant compressed in the compression chamber C3 is discharged into the discharge chamber C2 via the through-hole (discharge hole) 213 and the reed valve 214, and thereafter, is discharged to the refrigerant circuit (the high pressure side thereof) via the discharge port.

Here, in the housing 10, the fastening end portions 111 and 121 of the front housing 11 and the center housing 12 are welded to each other, and through this welding, a weld bead W1 is formed between the fastening end portion 111 of the front housing 11 and the fastening end portion 121 of the center housing 12. In the housing 10, the fastening end portions 122 and 131 of the center housing 12 and the rear housing 13 are welded to each other, and through this welding, a weld bead W2 is formed also between the fastening end portion 122 of the center housing 12 and the fastening end portion 131 of the rear housing 13. That is, the compressor 1 has a hybrid joining structure in which the fastening end portions (between the portions 111 and 121 and between the portions 122 and 131) are joined by both laser welding and fastening by the bolts 31 and 32.

In the present embodiment, the weld bead W1 is formed in the portions excluding the regions corresponding to the plurality of bolts 31 in the annular region between the fastening end portion 111 of the front housing 11 and the fastening end portion 121 of the center housing 12 (that is, the portions indicated by the shaded portions in FIG. 2 and indicated by the broken lines in FIG. 3). Similarly, the weld bead W2 is formed in the portions excluding the regions corresponding to the plurality of bolts 32 in the annular region between the fastening end portion 122 of the center housing 12 and the fastening end portion 131 of the rear housing 13 (that is, the portions indicated by the shaded portions in FIG. 2 and indicated by the broken lines in FIG. 4).

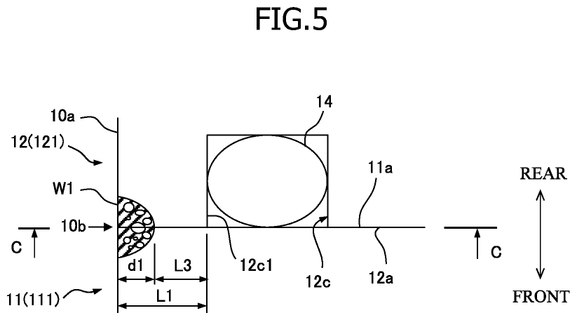

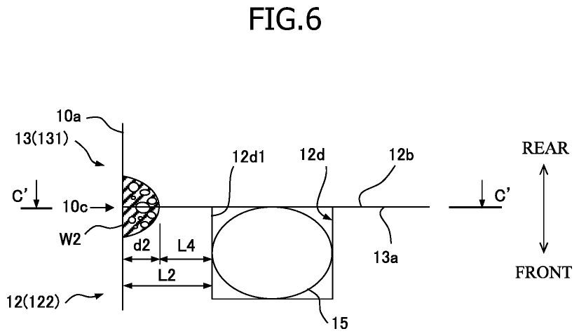

FIG. 5 is a partial enlarged sectional view taken along arrow line A-A of FIG. 3, and FIG. 6 is a partial enlarged sectional view taken along arrow line B-B of FIG. 3. As illustrated in FIG. 5, in the present embodiment, the front housing 11 and the center housing 12 are welded to each other from the housing outer surface 10a side (butt welding) in a state in which the respective end surfaces (the rear end surface 11a and the front end surface 12a) of the fastening end portions 111 and 121, are abutted each other. The weld bead W1 extends along the joining portion 10b which joins the rear end surface 11a of the front housing 11 and the front end surface 12a of the center housing 12 at the housing outer surface 10a, and is formed at each of the portions between the adjacent bolts 31 of the entire periphery of the joining portion 10b. As illustrated in FIG. 6, the center housing 12 and the rear housing 13 are welded to each other from the housing outer surface 10a side in a state in which the respective end surfaces (the rear end surface 12b and the front end surface 13a) of the fastening end portions 122 and 131 are abutted each other. The weld bead W2 extends along the joining portion 10c which join the rear end surface 12b of the center housing 12 and the front end surface 13a of the rear housing 13 at the housing outer surface 10a, and is formed at each of the portions between the adjacent bolts 32, 32 of the entire periphery of the joining portion 10c.

In the present embodiment, all of the front housing 11, the center housing 12, and the rear housing 13 are made of a casting aluminum alloy, and, as the welding system, laser welding is adopted, for example. The weld beads W1 and W2 are weld-solidified objects which are welded and solidified by laser application of the casting aluminum alloy as the base material, and have a bead width which corresponds to the laser spot diameter or the like.

In the present embodiment, the depths of weld penetration d1 and d2 from the housing outer surface 10a of the weld beads W1 and W2 are set to be smaller than the distances L1 and L2 from the housing outer surface 10a to the wall surfaces 12c1 and 12d1 on the outer side (the outer side in the housing radial direction) of the annular grooves 12c and 12d. The depths of weld penetration d1 and d2 are set, for example, to approximately 1 mm, which is smaller than in the prior art. The distance L3 between the distal end of the weld bead W1 and the wall surface 12c1, and the distance L4 between the distal end of the weld bead W2 and the wall surface 12d1, are greater than the depths of weld penetration d1 and d2, and are, for example, approximately 2 mm. The welding is performed in the state in which the O-rings 14 and 15 are accommodated in the annular grooves 12c and 12d. However, it has been confirmed that thermal deterioration of the O-rings 14 and 15 attributable to the welding heat is not generated when the proper distances L3 and L4 are secured while setting the depths of weld penetration d1 and d2 to be relatively small. The depths of weld penetration d1 and d2 and the distances L3 and L4 are set as appropriate mainly in accordance with the heat resistance or the like of the seal members such as the O-rings 14 and 15.

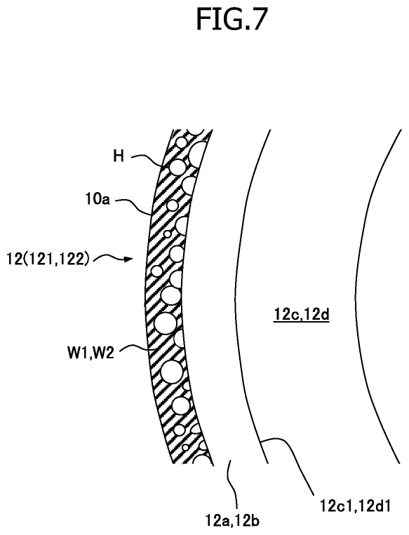

FIG. 7 is a sectional view taken along arrow line C-C of FIG. 5, and a conceptual view (a partial enlarged sectional view) taken along arrow line C′-C′ of FIG. 6. As illustrated in FIGS. 5 through 7, inside the weld beads W1 and W2, blow holes H are dispersed in the housing outer peripheral direction. The blow holes H tend to draw near to the distal end side of the weld beads W1 and W2 (the distal end side in the direction of the depths d1 and d2).

Here, in general, the blow holes are treated as defects in the weld beads, and are undesirable in a welding portion where, for example, strength is required. In welding between aluminum alloys, blow holes are relatively likely to be generated. Blow holes are more likely to be generated when the welding is performed in the atmospheric air. Furthermore, in general, the tensile strength of a weld bead obtained through weld-solidification of a base material (object of welding) through the laser welding is higher than the tensile strength of the base material. In the present embodiment, however, the tensile strength of the weld beads W1 and W2 is set to be lower than the tensile strength of the front housing 11, the center housing 12, and the rear housing 13 as the base material. More specifically, a casting aluminum alloy is adopted as the material of the housing 10, and, as illustrated in FIG. 7, the blow holes H, which are conventionally treated as inner defects, are intentionally formed by performing the laser welding in, for example, the atmospheric air. In this way, the blow holes H are intentionally dispersed in the weld beads W1 and W2, so that the tensile strength of the weld beads W1 and W2 is set to be lower than the tensile strength of the base material (11, 12, 13), and low strength welding is performed.

Next, the relationship between the welding strength and the tensile strength of the bolts 31 and 32 themselves will be described.

In the compressor 1, in a state in which the fastening by the plurality of bolts 31 is released (that is, in a state in which all the bolts 31 are removed), load when a tensile load is applied to the front housing 11 and the center housing 12 so as to separate the fastening end portions 111 and 121 from each other to cause the weld bead W1 to start to undergo plastic deformation, will be referred to as the breaking load F1. Similarly, in a state in which the fastening by the plurality of bolts 32 is released (that is, in a state in which all the bolts 32 are removed), load when a tensile load is applied to the center housing 12 and the rear housing 13 so as to separate the fastening end portions 122 and 131 from each other to cause the weld bead W2 to start to undergo plastic deformation, will be referred to as the breaking load F2. In the present embodiment, each bolt 31 exhibits a yield stress a1 that is greater than a stress generated therein when a tensile load f1 is applied thereto that is obtained by dividing the breaking load F1 by the number of the bolts 31. Similarly, each bolt 32 exhibits a yield stress a2 that is greater than a stress generated therein when a tensile load f2 is applied thereto that is obtained by dividing the breaking load F2 by the number of the bolts 32. That is, the strength of the welding portions (weld beads W1 and W2) is lower than the tensile strength of the bolts 31 and 32 themselves.

Next, a method of manufacturing the compressor 1 of the present embodiment will be described.

The manufacturing method of the compressor 1 of the present embodiment includes an assembly process, a fastening process, and a welding process.

In the assembly process, for example, the compression mechanism 20 is incorporated into the center housing 12, and, at the same time, an appropriate component such as the rotation hindering mechanism 43 is mounted, and an appropriate component such as the drive shaft 42 is mounted to the front housing 11.

In the fastening process, for example, first, the fastening end portion 111 of the front housing 11 to which each of the appropriate components is mounted and the fastening end portion 121 of the center housing 12 are fastened to each other by the plurality of bolts 31. After that, the fastening end portion 122 of the center housing 12 and the fastening end portion 131 of the rear housing 13 are fastened to each other by the plurality of bolts 32.

The welding process includes a front side welding process in which the welding at the joining portion 10b between the front housing 11 and the center housing 12 is performed, and a rear side welding process in which the welding at the joining portion 10c between the center housing 12 and the rear housing 13 is performed.

As the welding method, the present embodiment adopts laser welding. Although not illustrated, the welding apparatus includes, for example, a laser irradiation device and a work rotating device. The laser irradiation device may adopt a laser oscillation source of an appropriate system, such as disc laser, fiber laser, CO2 laser, YAG laser, or semiconductor laser. The work rotating device grasps the housing 10 and rotates it as appropriate, and can perform scanning along the joining portions 10b and 10c of the housing 10 with a laser beam emitted from the laser head of the laser irradiation device. Furthermore, the laser irradiation device is equipped with a shielding gas supply device blowing a shielding gas to the welding portions.

In the front side welding process, the fastening end portions 111 and 121 of the front housing 11 and the center housing 12 to which the appropriate components are mounted are welded to each other. More specifically, the fastening body obtained by fastening together the front housing 11 and the center housing 12 by the bolts 31 is grasped and rotated by the work rotating device, and the laser irradiation device applies a laser beam along the joining portion 10b between the rear end surface 11a of the front housing 11 and the front end surface 12a of the center housing 12 at the housing outer surface 10a. As a result, the weld beads W1 are formed between the fastening end portion 111 of the front housing 11 and the fastening end portion 121 of the center housing 12 (more specifically, between the rear end surface 11a and the front end surface 12a at the housing outer surface 10a side). In the present embodiment, the laser irradiation is performed solely with respect to the angular position between the adjacent bolts 31, 31 of the entire periphery of the joining portion 10b. Thus, of the portion between the rear end surface 11a and the front end surface 12a, the portions between the adjacent bolts 31, 31 where the surface pressure attributable to the axial force of the bolts 31 is relatively low and where gaps (so-called openings) can be generated, are filled with the weld beads W1.

In the rear side welding process, the fastening end portions 122 and 131 of the center housing 12 and the rear housing 13 are welded to each other. More specifically, the fastening body obtained by fastening together the rear housing 13 and the fastening body of the front housing 11 and the center housing 12 by the bolts 32 (that is, the housing 10 which accommodates the compression mechanism 20 therein, etc.) is grasped and rotated by the work rotating device, and the laser irradiation device applies a laser beam along the joining portion 10c between the rear end surface 12b of the center housing 12 and the front end surface 13a of the rear housing 13 at the housing outer surface 10a. As a result, the weld beads W2 are formed between the fastening end portion 122 of the center housing 12 and the fastening end portion 131 of the rear housing 13. In the present embodiment, the laser beam application is performed solely with respect to the angular position between the adjacent bolts 32, 32 of the entire periphery of the joining portion 10c. Thus, of the portion between the rear end surface 12b and the front end surface 13a, the portions between the adjacent bolts 32, 32 where the surface pressure attributable to the axial force of the bolts 32 is relatively low and where gaps (so-called openings) can be generated are filled with the weld beads W2.

In the present embodiment, the welding process is performed in the atmospheric air. Furthermore, in the present embodiment, the welding process is performed after the fastening process. That is, the welding process is performed, with a preload being applied between the fastening end portions (between the end portions 111 and 121, and between the end portions 122 and 131) as a result of the fastening process.

In the compressor 1 of the present embodiment, the front housing 11 and the center housing 12 are fastened to each other by a plurality of bolts 31, and the fastening end portions 111 and 121 of the front housing 11 and the center housing 12 are welded to each other, and by performing this welding, the weld beads W1 are formed between the fastening end portion 111 of the front housing 11 and the fastening end portion 121 of the center housing 12. Furthermore, the center housing 12 and the rear housing 13 are fastened to each other by a plurality of bolts 32, and the fastening end portions 122 and 131 of the center housing 12 and the rear housing 13 are welded to each other, and by performing this welding, the weld beads W2 are formed between the fastening end portion 122 of the center housing 12 and the fastening end portion 131 of the rear housing 13. That is, the compressor 1 has a hybrid joining structure in which the fastening end portions (between the portions 111 and 121, and between the portions 122 and 131) are joined by both welding and bolt fastening.

In the method of manufacturing the compressor 1 according to the present embodiment, in the fastening process, the fastening end portion 111 of the front housing 11 and the fastening end portion 121 of the center housing 12 are fastened to each other by a plurality of bolts 31, and, in the welding process, the fastening end portions (111, 121, and 122, 131) are welded to each other, whereby the weld beads are formed between the fastening end portions. That is, in the compressor manufacturing method according to the aspect of the invention, there is adopted a hybrid joining method in which the fastening end portions are joined together by using both laser welding and fastening by the fastening members.

Here, it is possible to easily ensure a reaction force to the load urging the fastening end portions (111, 121, and 122, 131) apart by a plurality of bolts 31 and 32, so that all or most of the pressure strength of the housing 10 can be borne by the plurality of bolts 31 and 32. As a result, regarding the welding portion between the front housing 11 and the center housing 12, and the welding portion between the center housing 12 and the rear housing 13, no strength with respect to pressure resistance or the like is required, and low strength welding is permitted. Thus, as compared with the prior art, it is possible, for example, to reduce the welding depth, and to relax the quality control with respect to welding such as the control with respect to the inner defects of the weld beads. Furthermore, the weld beads W1 and W2 are formed between the fastening end portions (between the portions 111 and 121, and between the portions 122 and 131), so that these weld beads W1 and W2 function as a shield wall with respect to the salt water or the like, making it possible to easily prevent or suppress intrusion of salt water or the like between the fastening end portions and the resultant corrosion between the fastening end portions. As a result, as compared with the prior art, it is possible, for example, to reduce the number of the bolts 31 and 32 and to relax the control of the fastening torque of the bolts 31 and 32.

In this way, in the compressor 1 of the present embodiment and the manufacturing method thereof, it is possible to prevent or suppress intrusion of salt water or the like between the fastening end portions of the plurality of housing members (11, 12, and 13) and the resultant corrosion between the fastening end portions while suppressing an increase in the production cost of the compressor for corrosion.

In the present embodiment, the blow holes H are dispersed within the weld beads W1 and W2 over the outer peripheral direction of the housing. As a result, it is possible to easily realize low strength welding. Low strength welding can be made not only by the blow holes H but also by merely reducing the depths of weld penetration d1 and d2.

Here, the corrosion between the end surfaces, in other words, gap corrosion between the mating surfaces, is generated due to a reduction in the oxygen concentration between the mating surfaces. In this respect, in the present embodiment, the rear end surface 11a of the front housing 11 and the front end surface 12a of the center housing 12, and the rear end surface 12b of the center housing 12 and the front end surface 13a of the rear housing 13 correspond to the mating surfaces. In the present embodiment, the weld beads W1 and W2 in which the blow holes H are formed are located between these mating surfaces. Thus, even if a crack or the like is generated in the weld beads W1 and W2 and salt water or the like intrudes the weld beads W1 and W2, there are formed the blow holes H all over the intrusion route, and thus, the blow holes H serve as the oxygen supply sources to be able to stop or retard the progress of the gap corrosion of the mating surfaces.

In the present embodiment, the weld beads W1 and W2 are formed in the portions excluding the regions which corresponds to the plurality of bolts 31 in the annular region between the fastening end portion 111 of the front housing 11 and the fastening end portion 121 of the center housing 12. That is, the welding range is restricted to the portions between the adjacent bolts (between the bolts 31 and between the bolts 32) of the entire periphery of the joining portions 10b and 10c. At the positions which corresponds to the bolts 31 and 32, the surface pressure attributable to the axial force of the bolts 31 and 32 is high, and scarcely any salt water or the like is allowed to enter from the joining portions 10b and 10c. Thus, in the present embodiment, a reduction in production cost is achieved by reducing the welding range.

In the present embodiment, the depths of weld penetration d1 and d2 of the weld beads W1 and W2 as measured from the housing outer surface 10a are set so as to be smaller than the distances L1 and L2 from the housing outer surface 10a to the outer wall surfaces 12c1 and 12d1 of the annular grooves 12c and 12d. As a result, it is possible to easily prevent or suppress thermal deterioration of the O-rings 14 and 15 as a seal member attributable to the welding heat.

In the present embodiment, the tensile strength of the weld beads W1 and W2 are set so as to be lower than the tensile strength of the front housing 11, the center housing 12, and the rear housing 13 as the welding base materials. As a result, for example, in a case in which the housing 10 is to be disassembled when scrapping the compressor 1, the portion of the weld bead W1 and W2 can be easily broken, so that it is possible to relieve the burden of the disassembling operation.

Furthermore, in the present embodiment, each bolt 31 exhibits a yield stress a1 that is greater than a stress generated therein when the tensile load f1 obtained through division of the breaking load F1 by the number of bolts 31 is applied thereto, and each bolt 32 exhibits a yield stress a2 that is greater than a stress generated therein when the tensile load f2 obtained through division of the breaking load F2 by the number of bolts 32 is applied thereto. Thus, in a case in which a tensile load is applied to both end portions of the housing 10 in a state in which the housing 10 is assembled, and the load is gradually increased, the welding portions (the weld beads W1 and W2) are broken prior to the bolts 31 and 32. As a result, in the compressor 1 having a hybrid joining structure in which the fastening end portions (between the portions 111 and 121, and between the portions 122 and 131) are joined by both laser welding and bolt fastening, all or most of the pressure strength of the housing 10 is borne by the plurality of bolts 31 and 32, and it is possible to cause the hybrid joining structure to become obvious in which the welding portions are of low strength welding.

In the present embodiment, the welding process is conducted in the atmospheric air. As a result, the blow holes H can be easily formed by using the water in the atmospheric air. It is preferable that the welding process is performed in an appropriate environment and under a welding condition in which the blow holes H are still easier to form. For example, it is preferable that the welding process is performed in the atmospheric air and in an environment of relatively high humidity, or in a state in which oil and water remain on the end surfaces (11a, 12a, 12b, and 13a) of the fastening end portions (111, 121, 122, and 131), or in a state in which the blowing amount of the shield gas is intentionally reduced or in which no shield gas is blown, or in an environment or a condition in which these are combined.

In the present embodiment, laser welding is adopted as the welding system, and the weld beads W1 and W2 are formed through laser welding. Here, in laser welding, it is possible to locally apply high density energy to the object of welding, so that it is possible to prevent or suppress deformation of the housing 10 due to the welding heat. Furthermore, in laser welding, the depths of weld penetration d1 and d2 can be controlled relatively easily, so that low strength welding can be easily performed.

In the present embodiment, the welding process is performed after the fastening process. As a result, the welding can be performed in a state in which positioning between the objects to be welded (11, 12, and 13) are reliably performed, so that it possible to improve the welding precision. Furthermore, it is possible to perform the welding process in a state in which a preload is applied between the fastening end portions (between the portions 111 and 121, and the portions 122 and 131) by the fastening process. The greater this preload, the more the generation of the blow holes H tends to be suppressed. For example, in a case in which the depths of weld penetration d1 and d2 are small, it is possible to form sufficient blow holes H even under the presence of a preload.

In a case in which pressure strength is required of the housing 10, fillet welding is preferable, whereas, in the present embodiment, no strength is required of the welding itself, so that butt welding can be adopted.

Next, some modifications of the described embodiment will be described. The following modifications can be combined with each other as appropriate.

In the present embodiment, the weld beads W1 are formed, of the entire periphery of the joining portion 10b, in the portions between the adjacent bolts 31; however, this should not be construed restrictively. The weld beads may be formed over the entire periphery in the housing outer peripheral direction (that is, over the entire periphery of the joining portion 10b). Similarly, while the weld beads W2 are formed, of the entire periphery of the joining portion 10c, in the portions between the adjacent bolts 32, this should not be construed restrictively. The weld beads may be formed over the entire periphery in the housing outer peripheral direction (that is, over the entire periphery of the joining portion 10c). This makes it possible to prevent or suppress intrusion of salt water or the like more reliably. In this case, when it is necessary to reduce the welding strength from the viewpoint of disassembly property of the housing 10, the depths of weld penetration d1 and d2 of the welding are further reduced.

Furthermore, although not illustrated, in order to relieve the disassembling operation of the housing 10, it is preferable to provide, for example, a protrusion at a portion adjacent to the joining portions 10b and 10c of the housing outer surface 10a (the weld beads W1 and W2). The housing 10 can be easily disassembled by striking the protrusion by a hammer or the like at the time of disassembling operation of the housing 10.

In the housing 10, there is adopted a butt joining structure in which the end surfaces (the rear end surface 11a and the front end surface 12a, and the rear end surface 12b and the front end surface 13a) of the housing members adjacent to each other are joined by directly abutting each other. This, however, should not be construed restrictively. A butt joining structure may be adopted in which an inclusion formed, for example, of an iron material such as a shim may be provided on the inner side of the housing outer surface 10a between the end surfaces (the rear end surface 11a and the front end surface 12a, and the rear end surface 12b and the front end surface 13a) of the housing members adjacent to each other, and in which joining is with the end surfaces indirectly abutting each other via this inclusion. In this case, the weld beads W1 and W2 are dissimilar metal weld-solidified objects obtained by weld and solidification of the base materials (11, 12, and 13) and the shim. Apart from the O-rings 14 and 15, it is possible to adopt other appropriate seal members such as gaskets. Furthermore, the housing 10 may have not only the butt joining structure, but also a fit-engagement joining structure in which the end surface portions are engaged with each other. In this case, the engaged portions are subjected to, for example, fillet welding.

While in the present embodiment and the described modifications the housing 10 is made of a casting aluminum alloy, this should not be construed restrictively. It may also be made of a forging aluminum alloy. As compared with a forging aluminum alloy, a casting aluminum alloy allows formation of the blow holes H more easily at the time of welding, and is a material of lower cost, so that a casting aluminum alloy is more desirable as the material of the housing 10.

While in the present embodiment and the described modifications, laser welding is adopted as the welding system, this should not be construed restrictively. It is also possible to adopt other appropriate welding systems such as spot welding and arc welding. Furthermore, while in the described examples the blow holes H are intentionally formed in the weld beads W1 and W2, this should not be construed restrictively, and no blow holes H may be formed. In this case, low strength welding is performed mainly by further reducing the depths of weld penetration d1 and d2 of the welding. Thus, in a case in which low strength welding is effected solely through the control of the depths of weld penetration d1 and d2, the welding may be performed not only in the atmospheric air but also in a vacuum.

In the present embodiment and the described modifications, the hybrid joining structure and joining method using both welding and bolt fastening are applied to both the joining portion between the front housing 11 and the center housing 12 and the joining portion between the center housing 12 and the rear housing 13. This, however, should not be construed restrictively, and the joining structure and joining method may be applied to one of the joining portions. As a result, it is possible to achieve a fixed effect of being capable of preventing or suppressing intrusion of salt water or the like between the fastening end portions of the plurality of housing members (11, 12, and 13) and the resultant corrosion between the fastening end portions while suppressing an increase in the production cost of the compressor 1 as compared with the prior art. The divisional portions of the housing 10, and the division number can be determined as appropriate. The hybrid joining structure and joining method are applied to at least one of the divisional portions.

In the present embodiment and the described modifications, solely the insertion portions of the bolts 31 and 32 of the fastening end portions 111, 121, 122, and 131 are formed so as to protrude outwards in the radial direction beyond the housing body portion. This, however, should not be construed restrictively, and all or part of the fastening end portions 111, 121, 122, and 131 may be formed in a flange-like configuration over the entire periphery without forming any lightening holes at the portions corresponding to the adjacent bolts.

Furthermore, while in the present embodiment and the described modifications the bolts 32 and 31 with head portions are employed as an example of the fastening members, this should not be construed restrictively. The fastening members are not restricted thereto. They may be the bolts 32 and 31 with head portions and nuts, or stud bolts with no head portions and nuts.

The present invention is not restricted to the described embodiment and modifications but allows further modifications and alterations based on the technical idea of the present invention.

### REFERENCE SYMBOL LIST

1 compressor
10 housing
10a housing outer surface
10b, 10c joining portion
11 front housing (housing member)
11a rear end surface (end surface)
12 center housing (housing member)
12a front end surface (end surface)
12b rear end surface (end surface)
12c, 12d annular groove
12c1, 12d1 wall surface
13 rear housing (housing member)
13a rear end surface (end surface)
14, 15 seal member
20 compression mechanism
31, 32 bolt (fastening member)
111, 121, 122, 131 fastening end portion
d1, d2 depth of weld penetration
L1, L1 distance
W1, W2 weld bead

1. A compressor comprising:
a housing made of an aluminum alloy; and
a compression mechanism accommodated in the housing,
wherein the housing has a first housing member and a second housing member which are fastened to each other by a plurality of fastening members and fastening end portions of which are welded to each other, with a weld bead being formed between the fastening end portion of the first housing member and the fastening end portion of the second housing member.

2. The compressor according to claim 1, wherein blow holes are dispersed within the weld bead over an outer peripheral direction of the housing.

3. The compressor according to claim 1, wherein the weld beads are formed in portions excluding the regions which corresponds to the plurality of fastening members in an annular region between the fastening end portion of the first housing member and the fastening end portion of the second housing member.

4. The compressor according to claim 1, wherein the first housing member and the second housing member are welded to each other from a housing outer surface side in a state in which the end surfaces of the respective fastening end portions of the first housing member and the second housing member, are abutted each other; and
the weld bead extends along a joining portion between the first housing member and the second housing member at the housing outer surface.

5. The compressor according to claim 1, wherein an annular groove which accommodates a seal member is formed in the fastening end portion of the first housing member or in the fastening end portion of the second housing member; and
a depth of weld penetration of the weld bead as measured from the housing outer surface is set to be smaller than a distance from the housing outer surface to an outer wall surface of the annular groove.

6. The compressor according to claim 1, wherein a tensile strength of the weld bead is set to be smaller than the tensile strength of the first housing member and of the second housing member.

7. The compressor according to claim 6, wherein the fastening members are bolts;
a breaking load is a load when the weld bead starts to undergo plastic deformation due to application of a tensile load to the first housing member and the second housing member so as to separate the fastening end portions from each other in a state in which the fastening by the plurality of bolts is released; and
each bolt exhibits a yield stress greater than a stress generated therein when there is applied thereto a tensile load obtained through division of the breaking load by the number of the bolts.

8. The compressor according to claim 2, wherein the weld beads are formed in portions excluding the regions which corresponds to the plurality of fastening members in an annular region between the fastening end portion of the first housing member and the fastening end portion of the second housing member.

9. The compressor according to claim 2, wherein the first housing member and the second housing member are welded to each other from a housing outer surface side in a state in which the end surfaces of the respective fastening end portions of the first housing member and the second housing member, are abutted each other; and
the weld bead extends along a joining portion between the first housing member and the second housing member at the housing outer surface.

10. The compressor according to claim 3, wherein the first housing member and the second housing member are welded to each other from a housing outer surface side in a state in which the end surfaces of the respective fastening end portions of the first housing member and the second housing member, are abutted each other; and
the weld bead extends along a joining portion between the first housing member and the second housing member at the housing outer surface.

11. The compressor according to claim 2, wherein an annular groove which accommodates a seal member is formed in the fastening end portion of the first housing member or in the fastening end portion of the second housing member; and
a depth of weld penetration of the weld bead as measured from the housing outer surface is set to be smaller than a distance from the housing outer surface to an outer wall surface of the annular groove.

12. The compressor according to claim 3, wherein an annular groove which accommodates a seal member is formed in the fastening end portion of the first housing member or in the fastening end portion of the second housing member; and
a depth of weld penetration of the weld bead as measured from the housing outer surface is set to be smaller than a distance from the housing outer surface to an outer wall surface of the annular groove.

13. The compressor according to claim 4, wherein an annular groove which accommodates a seal member is formed in the fastening end portion of the first housing member or in the fastening end portion of the second housing member; and
a depth of weld penetration of the weld bead as measured from the housing outer surface is set to be smaller than a distance from the housing outer surface to an outer wall surface of the annular groove.

14. The compressor according to claim 2, wherein a tensile strength of the weld bead is set to be smaller than the tensile strength of the first housing member and of the second housing member.

15. The compressor according to claim 3, wherein a tensile strength of the weld bead is set to be smaller than the tensile strength of the first housing member and of the second housing member.

16. The compressor according to claim 4, wherein a tensile strength of the weld bead is set to be smaller than the tensile strength of the first housing member and of the second housing member.

17. The compressor according to claim 5, wherein a tensile strength of the weld bead is set to be smaller than the tensile strength of the first housing member and of the second housing member.
